(19) United States
(12) Patent Application Publication
(10) Pub. No.: US 2011/0176671 A1
(43) Pub. Date: Jul. 21, 2011

(54) SYSTEM ARCHITECTURE AND METHOD FOR CONNECTING AN MSAN TO A MAIN DISTRIBUTION FRAME AND DISTRIBUTION FRAME TERMINATION

(75) Inventors: Heiko Neumetzler, Berlin (DE); Alexander William Gillespie, Kirkcaldy (GB)

(73) Assignee: ADC GmbH, Berlin (DE)

(21) Appl. No.: 13/000,949

(22) PCT Filed: Jun. 15, 2009
(86) PCT No.: PCT/EP09/04285

§ 371 Date: Apr. 1, 2011

(30) Foreign Application Priority Data
Jul. 3, 2008 (DE) 10 2008 031 521.4

(51) Int. Cl. H04Q 1/14; H01R 13/60; H04M 3/00

(52) U.S. Cl. 379/327; 439/540.1

(57) ABSTRACT

The invention relates to a system architecture (1) for linking an MSAN (2) to a main distribution frame (3), comprising at least one distribution frame connection module (10), which is arranged between the MSAN (2) and a system side (3a) of the main distribution frame (3), the distribution frame connection module (10) having a conductor connection side (10b) and a cable connection side (10a), it being possible for contacts of the conductor connection side (10b) to be connected to contacts of the cable connection side (10b), the distribution frame connection module (10) having a switching function, by means of which the connection between the conductor connection side (10b) and the cable connection side (10a) can be produced or interrupted, the MSAN (2) being connected to the cable connection side (10a) of the distribution frame connection module (10) via cables, and the system side (3a) of the main distribution frame (3) being connected to the conductor connection side (10b) of the distribution frame connection module (10) via conductors, and to a method for linking an MSAN (2) and an associated distribution frame connection module (10).

The invention relates to a system architecture and to a method for linking an MSAN to a main distribution frame and to a distribution frame connection module.

MSANs (multiservices access nodes) are network components in broadband connection networks which make available, in addition to the broadband services, analog telephone connection lines and ISDN connection lines using IP technology at the main distribution frame. The line termination takes place in the MSAN in the same way as the conversion of VoIP (voice-over-IP) in both transmission directions.

The existing main distribution frames have a subscriber side (line) and a system side, with jumpering between these two sides. The system side has, for example, connections to a PSTN (public switched telephone network) and a DSLAM, the low-frequency POTS (plain old telephone service) signals being filtered out by corresponding filter circuits (splitters) upstream of or in the DSLAM. If the intention is now to link an MSAN, the wiring must be correspondingly matched on the system side. In particular in the case of poor documentation of the existing wiring, this involves a considerable amount of complexity.

The invention is based on the technical problem of providing a system architecture and a method for linking a MSAN to a main distribution frame and to an associated distribution frame connection module, by means of which the linking process is facilitated.

The solution to the technical problem results from the subject matters having the features of patent claims 1, 5 and 6. Further advantageous configurations of the invention are given in the dependent claims.

The system architecture for linking an MSAN to a main distribution frame comprises at least one distribution frame connection module, which is arranged between the MSAN and a system side of the main distribution frame, the distribution frame connection module having a conductor connection side and a cable connection side, it being possible for contacts of the conductor connection side to be connected to contacts of the cable connection side, the distribution frame connection module having a switching function, by means of which the connection between the conductor connection side and the cable connection side can be produced or interrupted, the MSAN being connected to the cable connection side of the distribution frame connection module via cables, and the system side of the main distribution frame being connected to the conductor connection side of the distribution frame connection module via conductors. The basic concept is to leave the wiring on the system side of the main distribution frame unchanged, but for all of the conductors to additionally be connected to MSAN via the distribution frame connection module. If the intention is then for the MSAN to be brought into operation, the connection is produced via the switching function in the distribution frame connection module, with it being possible for the old conductor connections to DSLAMs or PSTNs to be removed.

In principle, the switching function can be realized by active technology with transistors or by means of relays. However, active technology permanently requires electrical energy. The use of relays can be configured more favorably if the rest position produces the connection between the cable connection side and the conductor connection side since in this case the relays only need to be energized before the switchover operation. However, the use of a large number of relays is cost-intensive.

Preferably, therefore, the switching function is realized by isolating contacts or switching contacts. In the case of the isolating contacts, isolating connectors are then used for producing the connection, while in the case of switching contacts, switching connectors are correspondingly used.

In an alternative embodiment, at least one female connector is arranged on the conductor connection side of the distribution frame connection module, and male connectors or male connector strips with conductor connection contacts can be plugged into said female connector, in a first plug-in position the male connectors being held merely mechanically in the female connector, but having no electrical contact with the contacts of the cable connection side, and in a second position the male connectors both being held mechanically and having electrical contact with the contacts of the cable connection side.

In a further preferred embodiment, at least one printed circuit board is arranged in the distribution frame connection module, and the contacts of the conductor connection side are connected to the contacts of the cable connection side via said printed circuit board. The contacts on the conductor connection side are preferably in the form of insulation displacement contacts or in the form of wire-wrap contacts.

The invention will be explained in more detail below with reference to a preferred exemplary embodiment. In the figures:

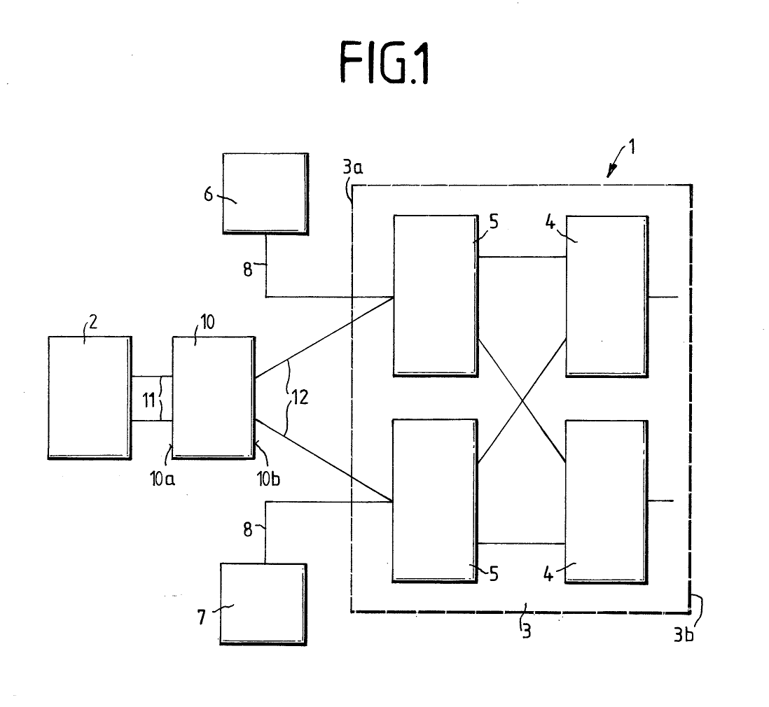

FIG. 1 shows a schematic block circuit diagram of a system architecture for linking an MSAN to a main distribution frame,

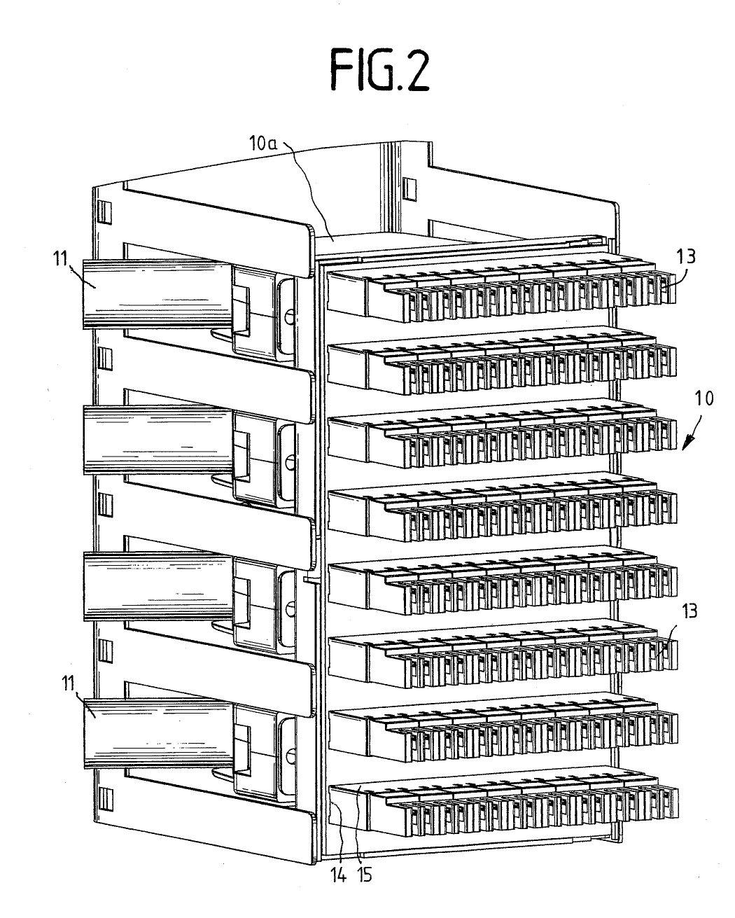

FIG. 2 shows a perspective front view of a distribution frame connection module,

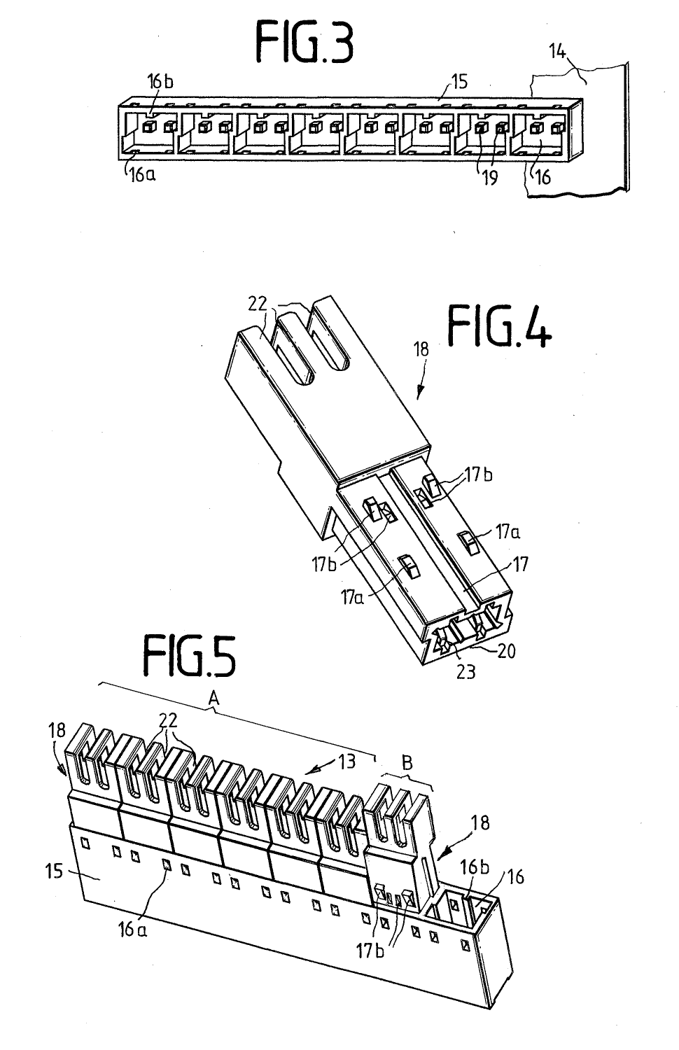

FIG. 3 shows a perspective plan view of a female connector,

FIG. 4 shows a perspective side view of a male connector, and

FIG. 5 shows a perspective plan view of a female connector with male connectors in a first position.

The system architecture 1 for linking an MSAN 2 to a main distribution frame 3 comprises at least one distribution frame connection module 10. The main distribution frame 3 comprises a system side 3a and a subscriber side 3b, the subscriber side 3b being formed by terminal blocks 4 and the system side 3a being formed by terminal blocks 5, between which the jumpering takes place. Then, conductors 8 are laid from the terminal blocks 5 to a switch 6 of a PSTN and to a DSLAM 7. The conductors 8 are in this case usually connected to the terminal blocks 5 in the form of twin conductors, which incidentally also applies to the conductors at the terminal blocks 4. For this purpose, the terminal blocks 4, 5 have conductor connection contacts, for example in the form of insulation displacement contacts or wire-wrap contacts.

The distribution frame connection module 10 has a cable connection side 10a and a conductor connection side 10b, the MSAN 2 being connected to the cable connection side 10a of the distribution frame connection module 10 via system cables 11. For this purpose, for example, plug-type connectors such as, for example, 37-pole D-sub plug-type connectors or 44-pole HD-D-sub plug-type connectors are arranged on the cable connection side 10a. Furthermore, conductors 12 are connected between the terminal blocks 5 and the conductor connection side 10b. The conductors 12 are in this case preferably twin conductors. However, it is in principle conceivable to also provide plug-type connectors for system cables on the conductor connection side 10b which are then split into twin conductors at the other end for the terminal blocks 5. The linking now takes place by first the MSAN 2 being connected to the cable connection side 10a. Then, the conductor connection contacts are connected to the conductors 12 on the conductor connection side 10b, with initially there not yet being an electrical connection between the cable connection side 10a and the conductor connection side 10b as a result of a switching function of the distribution frame connection module 10, which will be explained in more detail further below. In the next step, the opposite ends of the conductors 12 are then connected to the terminal blocks 5, with the result that the conductor connection contacts there are in each case wired twice, namely to the conductors 8 and to the conductors 12. Then, the connection between the conductor connection side 10b and the cable connection side is produced via the switching function and finally the conductors 8 are severed or removed. The connection assignments between the switch 6 and the terminal blocks 5 are usually not known, but they can be read, for example, at the cable connection side 10a or the conductor connection side 10b of the distribution frame connection module 10 and/or the DSLAM and the MSAN programmed correspondingly. In this case, it is possible to design the MSAN in such a way that it itself first determines the assignments and then programs itself correspondingly.

FIG. 2 illustrates an exemplary design of a distribution frame connection module 10. The conductor connection side 10b comprises eight strips 13, it being possible for each strip 13 to connect eight twin conductors, with the result that 64 twin conductors can be connected from the terminal block 5 to the distribution frame connection module in total. The strips 13 have, for example, press pins 19 (see FIG. 3) in order to connect the strips 13 to a printed circuit board 14. On the cable connection side 10a, the distribution frame connection module 10 has four 37-pole D-sub plug-type connectors, into which the system cables 11 for the MSAN can be plugged. Then, in each case two strips 13 are connected to a D-sub plug-type connector via the printed circuit board 14. In the example illustrated, trough-type fastening means are shown. However, alternative fastening means are also possible, for example by means of round bars.

The strip 13 comprises a female connector 15 (see FIG. 3), which has eight chambers 16. The inner side walls of the chambers 16 have latching means 16a and guides 16b, which interact with latching means 17a, 17b of a male connector 18 (see FIG. 4). The press pins 19 of the strips 13 which are plugged partially into the printed circuit board 14 are dimensioned in such a way that their opposite end in the form of a square protrudes into the chambers 16. In this case, in each case two press pins 19 per chamber 16 protrude inwards, with the result that in each case one twin conductor can be connected. The male connectors 18 have in each case two contact elements, which each have two contacts, namely an insulation displacement contact 22 and a fork contact 23, which is accessible from the lower side 20. If, as shown in FIG. 5, the male connector 18 is now plugged with the lower side 20 into the chamber 16, it latches in, in a first position B, onto the first latching means 17a, the fork contact 23 not yet coming into electrical contact with the press pins 19. If the male connector 18 is then pushed further downwards into a second position A, the male connector 18 latches in with the second latching means 17b and the fork contact 23 makes contact with the press pin 19.

FIG. 5 illustrates the strip with six male connectors 18 inserted into the female connector 15 in the second position A and with one male connector 18 inserted into the female connector 15 in the first position B, the right-hand chamber 16 of the female connector 15 being empty. Instead of the 1 twin-conductor male connector 18, male connector strips with different pitches, such as 4, 8 or 10 twin conductors, for example, are also conceivable. The female connector 15 can also have, for example, more or fewer chambers 16. For example, it can be provided that the female connector 15 has only one chamber 16 for an 8 twin-conductor male connector strip.

### LIST OF REFERENCE SYMBOLS

1 system architecture
2 MSAN
3 main distribution frame
3a system side
3b subscriber side
4, 5 terminal blocks
6 switch
7 DSLAM
8 conductors
10 distribution frame connection module
10a cable connection side
10b conductor connection side
11 system cable
12 conductors
13 strip
14 printed circuit board
15 female connector
16 chambers
16a latching means
16b guides
17a, 17b latching means
18 male connector
19 press pins
20 lower side
22 insulation displacement contact
23 fork contact
A, B positions

1. A system architecture for linking an MSAN to a main distribution frame, comprising at least one distribution frame connection module, which is arranged between the MSAN and a system side of the main distribution frame, the distribution frame connection module having a conductor connection side and a cable connection side, it being possible for contacts of the conductor connection side to be connected to contacts of the cable connection side, the distribution frame connection module having a switching function, by wherein the connection between the conductor connection side and the cable connection side can be produced or interrupted, the MSAN being connected to the cable connection side of the distribution frame connection module via cables, and the system side of the main distribution frame being connected to the conductor connection side of the distribution frame connection module via conductors.

2. The system architecture as claimed in claim 1, wherein the switching function is realized by isolating contacts or switching contacts.

3. The system architecture as claimed in claim 1, wherein at least one female connector is arranged on the conductor connection side of the distribution frame connection module, and male connectors or male connector strips with conductor connection contacts can be plugged into said female connector, it being possible for the male connectors to be plugged into the female connector in two positions, in a first plug-in position the male connectors being held merely mechanically in the female connector, but having no electrical contact with the contacts of the cable connection side, and in a second position the male connectors both being held mechanically and having electrical contact with the contacts of the cable connection side.

4. The system architecture as claimed in claim 1, wherein at least one printed circuit board is arranged in the distribution frame connection module, and the contacts of the conductor connection side are connected to the contacts of the cable connection side via said printed circuit board.

5. A distribution frame connection module, comprising a conductor connection side and a cable connection side, it being possible for contacts of the conductor connection side to be connected to contacts of the cable connection side, the distribution frame connection module having a switching function, wherein the connection between the conductor connection side and the cable connection side can be produced or interrupted, wherein at least one female connector is arranged on the conductor connection side of the distribution frame connection module, and male connectors or male connector strips with conductor connection contacts can be plugged into said female connector, it being possible for the male connectors to be plugged into the female connector in two positions, in a first plug-in position the male connectors being held merely mechanically in the female connector, but having no electrical contact with the contacts of the cable connection side, and in a second position the male connectors both being held mechanically and having electrical contact with the contacts of the cable connection side.

6. A method for linking an MSAN to an existing, wired main distribution frame by a system architecture including at least one distribution frame connection module, which is arranged between the MSAN and a system side of the main distribution frame, the distribution frame connection module having a conductor connection side and a cable connection side, it being possible for contacts of the conductor connection side to be connected to contacts of the cable connection side, the distribution frame connection module having a switching function, wherein the connection between the conductor connection side and the cable connection side can be produced or interrupted, the MSAN being connected to the cable connection side of the distribution frame connection module via cables, and the system side of the main distribution frame being connected to the conductor connection side of the distribution frame connection module via conductors, comprising the following method steps:
a) connecting the distribution frame connection module to the MSAN and the main distribution frame,
b) producing the connection between the contacts of the conductor connection side (10b) and the cable connection side of the distribution frame connection module (10) by the switching function, and
c) disconnecting the old wiring on the system side of the main distribution frame.
